(19) United States
(12) Patent Application Publication
(10) Pub. No.: US 2024/0001832 A1
(43) Pub. Date: Jan. 4, 2024

(54) CARGO-LOADING SYSTEM AND METHOD FOR CARGO VEHICLE

(71) Applicants: Hyundai Motor Company, Seoul (KR); Kia Corporation, Seoul (KR)

(72) Inventors: Sang Heon LEE, Seoul (KR); Dong Eun CHA, Hwaseong-si (KR); Jin Ho HWANG, Cheonan-si (KR)

(73) Assignees: Hyundai Motor Company, Seoul (KR); Kia Corporation, Seoul (KR)

(21) Appl. No.: 17/977,234

(22) Filed: Oct. 31, 2022

(30) Foreign Application Priority Data
Jun. 30, 2022 (KR) 10-2022-0080676

(51) Int. Cl. B60P 1/64; B65G 67/20

(52) U.S. Cl. CPC B60P 1/6409; B60P 1/6481; B65G 67/20; B60P 3/007

(57) ABSTRACT

A cargo loading system for a cargo vehicle includes a carrier device provided in a loading space of the cargo vehicle to move cargoes in the loading space, a setting unit configured to set a loading position for each cargo in which each cargo is located in the loading space of the cargo vehicle based on basic information of each of the cargoes, and a control unit configured to control operation of the carrier device according to a loading position of a corresponding cargo set in the setting unit when the corresponding cargo is loaded on the carrier device so that the corresponding cargo reaches the loading position matching the corresponding cargo.

### CROSS-REFERENCE TO RELATED APPLICATION(S)

The present application claims priority to Korean Patent Application No. 10-2022-0080676, filed on Jun. 30, 2022, the entire contents of which is incorporated herein for all purposes by this reference.

### BACKGROUND OF THE PRESENT DISCLOSURE

### Field of the Present Disclosure

The present disclosure relates to a cargo loading system and a cargo loading method for a cargo vehicle, and specifically, to a technology for disposing and loading cargo in a cargo vehicle.

### Description of Related Art

The logistics industry of small and large cargo, using ships, aircrafts, and vehicles, has been continuously developed with the development of industry. In recent years, a service industry such as the parcel delivery has grown as a new industry in logistics.

With the development of industry, the quantitative growth of logistics is continuously made, while the logistics industry requires not only quantitative growth but also qualitative growth in a customer service level. However, the existing foundation is sufficient in many aspects.

When a large amount of loaded cargo is mixed and carried, there may be many problems such as misclassification of goods, the confusion between containers in which cargo is to be loaded, or incorrect determination on whether cargo has been loaded in a container.

In the case of relying only on a recording method using printed media on documents, it is often the case that information such as the weight or volume of cargo is inaccurate and the actually loaded position of the cargo cannot be identified. In the instant case, it may take a lot of time to find the cargo during unloading, or a cargo ordering company may refuse to receive the cargo due to the loss of the cargo or the insufficient quantity and misdelivery of the cargo.

When the loading position of cargo in a process of loading or distribution thereof is unclear, a subject responsible therefor is unclear, and the cargo is misdelivered or lost, it is unclear where responsibility lies, and it is thus impossible to provide a high-quality logistics service and to fully protect customers. The above various problems related to loading in the logistics industry may bring about a decline in credit rating and waste of time and manpower due to failing to deliver cargo to a right place, causing economic damage.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a loading space of a cargo vehicle in the upward/downward direction and the forward/backward direction of the vehicle, arrange loading positions of cargo, based on the delivery order or weight of the cargo, dispose a transfer device for transferring cargo to a loading space, and transfer disposed cargo to the loading space through the transfer device, efficiently loading the cargo.

A cargo loading system for a cargo vehicle according to an exemplary embodiment of the present disclosure may include: a carrier device provided in a loading space of the cargo vehicle to move cargoes in the loading space; a setting unit configured to set a loading position for each cargo in which each cargo is located in the loading space of the cargo vehicle based on information of each of the cargoes; and a control unit configured to control operation of the carrier device according to a loading position of a corresponding cargo set in the setting unit when the corresponding cargo is loaded on the carrier device so that the corresponding cargo reaches the loading position matching the corresponding cargo.

The loading space of the cargo vehicle may be divided into a plurality of vertical layers, and the setting unit may set positions of the layers on which the cargoes are loaded according to a weight of the cargoes included in the information of the cargoes.

The setting unit may place the cargo on the lower layer of the loading space as the weight of the cargo included in the information of the cargo increases.

The setting unit may set the loading position of the loading space according to an order of delivery from a hub where the cargoes included in the information of the cargoes are loaded to a delivery location.

The setting unit may place the cargoes closer to an entrance of the loading space as a delivery priority of the cargoes is higher.

The cargo loading system may further include an input unit configured to recognize the loaded cargo and to input the loading position of the cargo set by the setting unit to the control unit when the cargo is recognized, wherein the loading position of the cargo is input through the input unit of the cargo when an operator loads the cargo, and the control unit is configured to control the carrier device to carry the cargo to the loading position when the loading position of the cargo is input by the input unit.

The cargo loading system may further include a detection unit provided at a position where the cargo is loaded in the loading space to detect the cargo and to be connected to the setting unit to confirm the loading position of the cargo.

When the cargo detected by the detection unit is different from the loading position set by the setting unit, the control unit may generate a warning signal through a portable terminal of the operator.

The loading space may be divided into a left space and a right space at a left side and a right side of the vehicle, and the carrier device is located between the left space and the right space to carry the cargo in the forward and rearward directions of the vehicle.

A method for loading a cargo by a cargo vehicle according to an exemplary embodiment of the present disclosure may include: setting a loading position of a cargo in a loading space of the cargo vehicle based on a delivery order or a weight of the cargo; and controlling a carrier device provided in the loading space of the cargo vehicle to move the cargo in the loading space so that the cargo is carried to the loading position based on a delivery position set in the setting.

The method may further include: loading the cargo on the carrier device before the controlling; and recognizing information of the cargo loaded on the carrier device and inputting a loading position of the recognized cargo, wherein the controlling includes controlling the carrier device so that the cargo is carried to the loading position of the cargo when the loading position is input in the inputting.

The method may further include: determining whether the loading position of the cargo is in the loading space or on the carrier device after the inputting; and loading the cargo in a temporary space of the loading space when the loading position of the cargo is on the carrier device in the determining.

The method may further include: determining whether all cargoes are input in the inputting after the inputting; and loading the cargo loaded in the temporary space on the carrier device when it is determined that all cargoes are input in the inputting in the determining.

When it is determined that all cargoes are not input in the inputting in the determining, the loading of the cargo on the carrier device, the inputting, and the controlling may be repeatedly performed.

The method may further include: dividing the loading space into a plurality of layers and setting the layers of the loading space according to a weight of the cargo in the setting; and loading the cargo on the corresponding layer after controlling the carrier device so that the cargo is carried to the loading position in the controlling.

The method may further include confirming that the cargo is loaded at the set loading position through a detection unit provided in the loading space when the cargo is loaded in the loading space after the loading.

According to an exemplary embodiment of the present disclosure, the cargo-loading system and the cargo-loading method for a cargo vehicle may divide a loading space of a cargo vehicle in the forward/backward direction of the vehicle and arrange loading positions of cargo at an entrance side, based on the delivery order of the cargo so that a delivery driver can efficiently deliver the cargo.

Furthermore, the cargo-loading system and the cargo-loading method may divide the loading space of the cargo vehicle in the upward/downward direction of the vehicle and arrange heavier cargo at the lower side of the loading space, reducing the probability that a worker will be injured due to the weight of cargo when loading the cargo in the loading space of the cargo vehicle.

Furthermore, the transfer device may be provided in the loading space of the cargo vehicle to transfer cargo in the loading space, and the cargo may be transferred to a loading position through the transfer device, reducing fatigue felt by the worker while loading the cargo in the loading space of the cargo vehicle, and thus improving the efficiency of cargo loading work.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view showing a cargo vehicle according to an exemplary embodiment of the present disclosure.

FIG. 2 is a rear view showing a cargo vehicle according to an exemplary embodiment of the present disclosure.

FIG. 3 is a plan cross-sectional view showing a cargo vehicle according to an exemplary embodiment of the present disclosure.

FIG. 4 is a block diagram showing a cargo loading system for a cargo vehicle according to an exemplary embodiment of the present disclosure.

FIG. 5 is a flowchart showing a cargo loading method for a cargo vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, and the same or similar elements are provided the same and similar reference numerals, so duplicate descriptions thereof will be omitted.

The terms “module” and “unit” used for the elements in the following description are provided or interchangeably used in consideration of only the ease of writing the specification, and do not have distinct meanings or roles by themselves.

In relation to describing the exemplary embodiments disclosed in the present specification, when the detailed description of the relevant known technology is determined to unnecessarily obscure the gist of the present disclosure, the detailed description may be omitted. Furthermore, the accompanying drawings are provided only for easy understanding of the exemplary embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

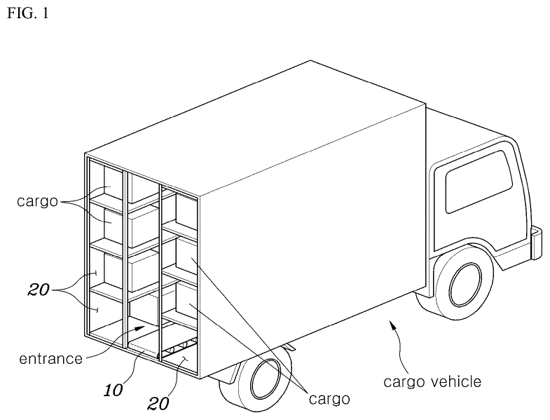

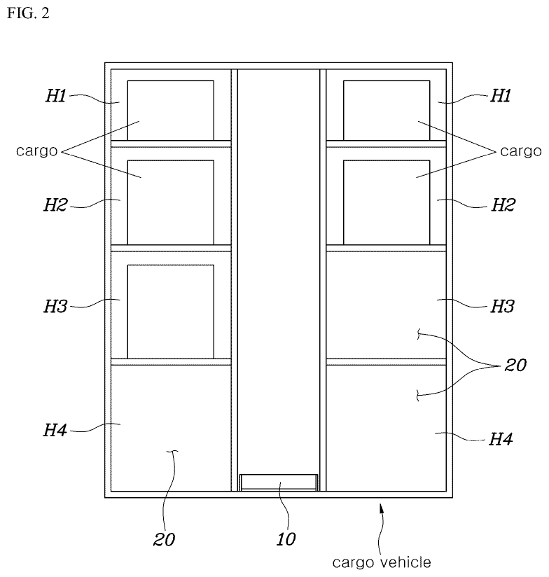

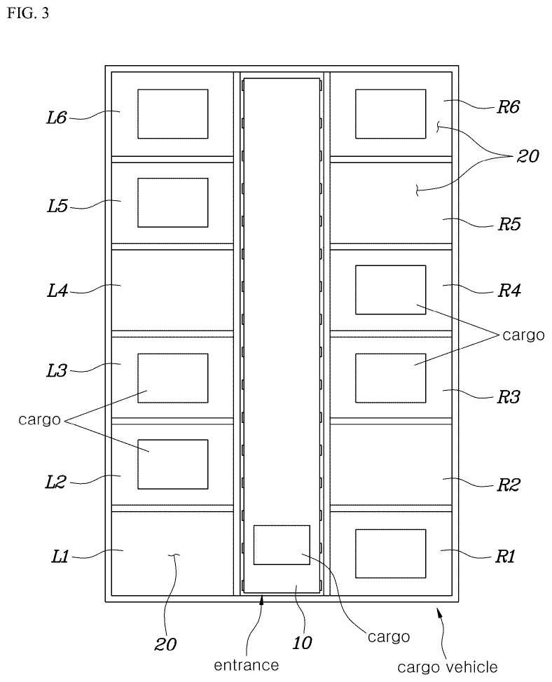

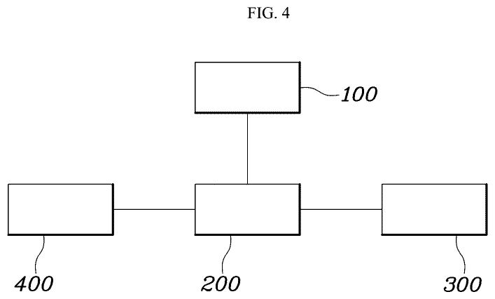

FIG. 1 is a perspective view showing a cargo vehicle according to an exemplary embodiment of the present disclosure, FIG. 2 is a rear view showing a cargo vehicle according to an exemplary embodiment of the present disclosure, FIG. 3 is a plan cross-sectional view showing a cargo vehicle according to an exemplary embodiment of the present disclosure, and FIG. 4 is a block diagram showing a cargo loading system for a cargo vehicle according to an exemplary embodiment of the present disclosure.

An exemplary embodiment of a cargo loading system for a cargo vehicle according to the present disclosure will be described with reference to FIG. 1, FIG. 2, FIG. 3, and FIG. 4.

In a conventional cargo vehicle, a space for loading cargoes is simply provided, and a delivery driver or an operator who loads the cargoes directly sets the order for loading the cargoes and loads the cargoes on a loading space 20, which is inefficient.

The present disclosure is devised to solve the problem of inefficient cargo loading.

A cargo loading system for a cargo vehicle according to the present disclosure includes a carrier device 10 provided in the loading space 20 of the cargo vehicle to move cargoes in the loading space 20; a setting unit 100 configured to set a loading position for each cargo in which each cargo is located in the loading space 20 of the cargo vehicle based on basic information of each of the cargoes; and a control unit 200 configured to control the operation of the carrier device 10 according to a loading position of a corresponding cargo set in the setting unit 100 when the cargo is loaded on the carrier device 10 so that the cargo reaches the loading position matching the cargo.

As shown in FIG. 1, FIG. 2, and FIG. 3, the cargo of the cargo vehicle may be loaded into the cargo vehicle at a delivery hub and may then delivered to a delivery destination.

The setting unit 100 may input the basic information of the plurality of cargoes loaded on the cargo vehicle from an external server, and the setting unit 100 may load the cargo into the vehicle based on the basic information of the plurality of cargoes.

The basic information of the cargo may include the size of the cargo, the amount of the cargo, a delivery destination, and whether to be careful about handling the cargo.

The setting unit 100 may set an optimal transfer route of the cargo vehicle based on the location of the delivery destination among the basic information of the cargo. In the instant case, the setting unit 100 may set the loading order of the cargoes based on the set optimal transfer route of the cargo vehicle. Furthermore, when the delivery location is adjacent to the cargo, the setting unit 100 may set the loading order of the cargoes in the vertical direction according to the weight of the cargo among the basic information of the cargo.

The carrier device 10 may be provided in the loading space 20 of the cargo vehicle, and may be provided to carry the cargo in the front and rear direction of the vehicle.

As an exemplary embodiment of the carrier device 10, the carrier device 10 may be provided on the layer of the loading space 20 and may be provided in a form of a conveyor belt, and the carrier device 10 may transfer the cargo from the loading space 20 to the loading position.

The control unit 200 may control the carrier device 10 so that the cargo is carried to the loading position of the cargo set by the setting unit 100 in the loading space 20 by the carrier device 10.

Through this, it is possible to reduce the probability of injury to the operator due to the weight of the cargo when the delivery driver or worker loads the cargo in the loading space 20 of the cargo vehicle. Furthermore, it is possible to improve the efficiency of an operation of loading the cargo by reducing the fatigue that occurs when the cargo is loaded.

The loading space 20 of the cargo vehicle may be divided into a plurality of vertical layers, and the setting unit 100 may set the position of the layer on which the cargo is loaded according to the weight of the cargo included in the basic information of the cargo.

As shown in FIG. 1 and FIG. 2, the loading space 20 of the cargo vehicle may be formed in a plurality of layers divided into the vertical direction, and the setting unit 100 may set the loading position according to the weight of the cargo when setting the loading position of the cargo on the layer divided into the loading space 20.

In general, when a delivery of the cargo is received, the weight of the cargo may be checked among the basic information of the cargo and the weight of the cargo may be input to an external server, and the setting unit 100 may receive the weight of the cargo from the external server to arrange the vertical position where the cargo is loaded according to the weight of the cargo.

The setting unit 100 may arrange the cargo in the lower layer of the loading space 20 as the weight of the cargo increases.

As shown in FIG. 2, the loading space 20 in which the cargo is loaded may be formed in a plurality of layers divided in the vertical direction, and the setting unit 100 may number the vertically divided layers by the number of layers from H1.

In an exemplary embodiment of the present disclosure, H1 may be the uppermost layer, and the numbering may be incremented by one as H2, H3, and H4 as the layer is the lower layer. The setting unit 100 may arrange the cargo to be loaded in the lower loading space 20 as the weight of the cargo is increased. Through this, the worker who loads the cargo loads the cargo at the cargo position set in the setting unit 100, reducing the time required to set the loading position of the cargo to improve the efficiency of work. Furthermore, the heavier cargo may be loaded on the lower layer, reducing the probability of injury to the operator.

The setting unit 100 may set the loading position of the loading space 20 according to the order of delivery from a hub where the cargo included in the basic information of the cargo is loaded to the delivery location.

As shown in FIG. 3, the setting unit 100 may divide the loading space 20 into a left space and a right space at a left side and a right side of the vehicle, and may arrange the cargoes according to the order in which the cargo is delivered.

As an exemplary embodiment of the present disclosure, the setting unit 100 may set the left loading space 20 as L1, L2, L3, L4, L5 and L6 and set the right loading space 20 as R1, R2, R3, R4, R5 and R6 by dividing the loading space 20 of the cargo as shown in FIG. 3, arranging the cargoes based on a delivery priority according to the set delivery route.

The setting unit 100 may arrange the cargo closer to an entrance of the loading space 20 as the delivery priority of the cargo is higher.

The loading space 20 of the cargo shown in FIG. 3 may be divided into L1, L2, L3, L4, L5 and L6 and R1, R2, R3, R4, R5 and R6, and the setting unit 100 may set the loading position so that the cargo is disposed closer to the entrance of the loading space 20 as the delivery priority is higher and the cargo is disposed away from the entrance as the delivery priority is lower.

Through this, the delivery driver may deliver the cargo in the order in which the cargoes are loaded, increasing the efficiency of cargo delivery.

The cargo loading system may further include an input unit 300 configured to recognize the loaded cargo and to input the loading position of the cargo set by the setting unit 100 to the control unit 200 when the cargo is recognized, wherein the loading position of the cargo may be input through the input unit 300 of the cargo when an operator loads the cargo, and the control unit 200 may control the carrier device 10 to carry the cargo to the loading position when the loading position of the cargo is input by the input unit 300.

The input unit 300 may be provided in a portable terminal to recognize the cargo, and the recognition of the cargo may be performed in various ways.

When the operator loads the cargo in the loading space 20, the cargo may be first loaded on the transfer device 10, and at the instant time, the operator may recognize an invoice provided for the cargo through the portable terminal. For example, a barcode may be provided on the invoice, the barcode may be recognized through the portable terminal, and upon recognition, the delivery location and loading position of the cargo may be input through the input unit 300. The control unit 200 may control the transfer device 10 to carry the cargo to the loading position of the cargo input through the input unit 300.

Through this, the control unit 200 may confirm that the cargo has been moved on the carrier device 10 and may control the carrier device 10 to carry the cargo to the loading position thereof. Here, the operator may load the cargo carried to the carrier device 10 on the layer of the loading space 20 set in the setting unit 100.

In the instant case, when the operator recognizes the cargo through the portable terminal, the operator may check the fact that the loading position of the cargo is exposed on the portable terminal or the loading position of the cargo is written on the invoice attached to the cargo, and may then load the cargo.

The cargo loading system may further include a detection unit 400 provided at a position where the cargo is loaded in the loading space 20 to detect the cargo, and to be connected to the setting unit 100 to confirm the loading position of the cargo.

The detection unit 400 configured to detect information of the cargo when the cargo is loaded may be provided in the loading space 20, and the detection unit 400 may detect that the cargo is correctly loaded by comparing the information of the cargo detected by the detection unit 400 with the loading position of the cargo set by the setting unit 100.

A plurality of detection units 400 may be provided in the loading position of the cargo to detect all the cargoes loaded on the vehicle. Furthermore, as an exemplary embodiment of the detection unit 400, the invoice may be attached to the cargo, and the detection unit 400 may recognize the barcode written on the invoice to confirm the loading position of the cargo.

When the cargo detected by the detection unit 400 is different from the loading position set by the setting unit 100, the control unit 200 may generate a warning signal through the operator's portable terminal.

When the loading position of the cargo detected by the detection unit 400 and the loading position of the corresponding cargo set by the setting unit 100 are different from each other, the control unit 200 may generate a warning signal through the portable terminal of the operator who loads the cargo.

Through this, the operator may rapidly change the loading position of the cargo to load the cargo to the loading position set by the setting unit 100.

The loading space 20 may be divided into a left space and a right space at a left side and a right side of the vehicle, and the carrier device 10 may be located in the loading space 20 between the left space and the right space to carry the cargo in the forward and rearward directions of the vehicle.

As shown in FIG. 3, the loading space 20 may be divided into a left loading space and a right loading space at the left and the right side of the vehicle, and the carrier device 10 may be located between the loading spaces 20 on both sides, so that the cargo may be carried to the loading position through the carrier device 10, the cargo may be loaded in the loading space 20 by the operator, and the cargo may be also loaded on the carrier device 10 after the loading of the cargo in the loading space 20 is completed.

Through this, even a space in which the carrier device 10 located in the loading space 20 is provided may be utilized.

Furthermore, the setting unit 100 may increase the delivery efficiency of the delivery driver by setting the cargo loaded on the carrier device 10 as the cargo delivered with the highest priority.

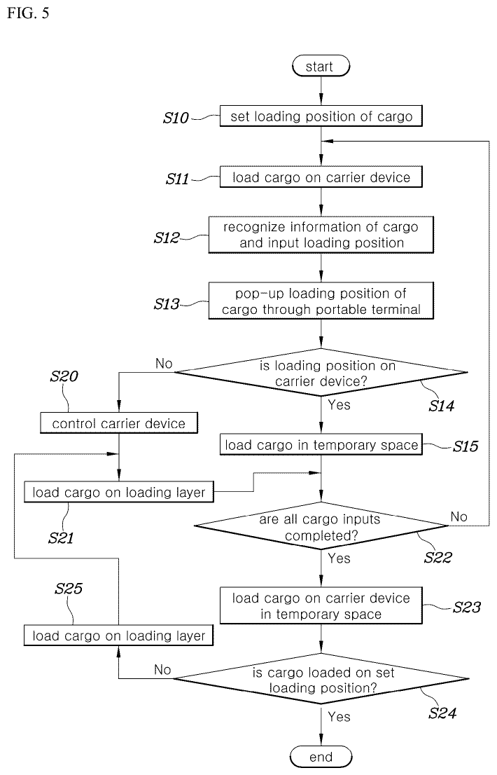

FIG. 5 is a flowchart showing a cargo loading method for a cargo vehicle according to an exemplary embodiment of the present disclosure.

An exemplary embodiment of a cargo loading method for a cargo vehicle according to the present disclosure will be described with reference to FIG. 5.

The cargo loading method for the cargo vehicle according to the present disclosure may include setting (S10) a loading position of a cargo in a loading space 20 of the cargo vehicle based on a delivery order or a weight of the cargo; and controlling (S20) a carrier device 10 provided in the loading space of the cargo vehicle to move the cargo in the loading space 20 so that the cargo is carried to the loading position based on a delivery position set in the setting (S10).

The cargo loading method may further include loading (S11) the cargo on the carrier device 10 before the controlling (S20); and recognizing information of the cargo loaded on the carrier device 10 and inputting (S12) a loading position of the recognized cargo, wherein the controlling (S20) may include controlling the carrier device 10 so that the cargo is carried to the loading position of the cargo when the loading position is input in the inputting (S12). In the inputting (S12), an operator may input a barcode on an invoice attached to the cargo loaded in the loading (S11) through a portable terminal, and may transmit the barcode to the control unit 100. Next, the control unit 100 may control the carrier device 10 to carry the cargo to the loading position.

After the inputting (S12), the cargo loading method may further include popping-up (S13), by the control unit 300, the loading position of the cargo through the operator's portable terminal.

The operator may confirm the loading position of the cargo popped-up on a screen of the portable terminal, and may load the cargo carried through the carrier device to the loading position.

The cargo loading method may further include determining (S14) whether the loading position of the cargo is in the loading space 20 or on the carrier device 10 after the inputting (S12); and loading (S15) the cargo in a temporary space of the loading space 20 when the loading position of the cargo is on the carrier device 10 in the determining.

The cargo loading method may further include determining (S22) whether all cargoes are input in the inputting after the inputting (S12); and loading (S23) the cargo loaded in the temporary space on the carrier device 10 when it is determined that all cargoes are input in the inputting (S12) in the determining (S22).

When it is determined that all cargoes are not input in the inputting (S12) in the determining (S22), the loading of the cargo on the carrier device 10, the inputting (S12), and the controlling (S20) may be repeatedly performed.

In the loading (S11), the carrier device 10 may load the amount of cargo which may be carried at once. Next, the inputting (S12) may be performed, the carrier device 10 may transfer the cargo, and the operator may load the cargo in the loading space.

The cargo loading method may further include dividing the loading space 20 into a plurality of layers and setting the layers of the loading space 20 according to a weight of the cargo in the setting (S10); and loading (S21) the cargo on the corresponding layer after controlling the carrier device 10 so that the cargo is carried to the loading position in the controlling (S20).

In the controlling (S20) after the loading (S21), the carrier device 20 may be controlled to be moved to its original position to prepare to carry the next cargo.

The cargo loading method may further include confirming (S24) that the cargo is loaded at the set loading position through a detection unit 400 provided in the loading space 20 when the cargo is loaded in the loading space after the loading (S21).

In the confirming (S24), the fact that the cargo is loaded at the loading position of the cargo set in the setting (S10) may be confirmed, and generating (S25) a signal to the operator's portable terminal may be performed when the cargo is not loaded at the set loading position.

Accordingly, the operator may repeatedly perform the loading (S21) of loading the cargo, and may load all the cargoes at the set position.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A cargo loading system for a cargo vehicle, the cargo loading system comprising:
a carrier device provided in a loading space of the cargo vehicle to move cargoes in the loading space;
a setting unit configured to set a loading position for each cargo in which each cargo is located in the loading space of the cargo vehicle based on information of each of the cargoes; and
a control unit configured to control operation of the carrier device according to a loading position of a corresponding cargo set in the setting unit when the corresponding cargo is loaded on the carrier device so that the corresponding cargo reaches the loading position matching the corresponding cargo.

2. The cargo loading system of claim 1, wherein the loading space of the cargo vehicle includes a plurality of vertical layers, and the setting unit is configured to set positions of the vertical layers on which the cargoes are loaded according to a weight of the cargoes included in the information of the cargoes.

3. The cargo loading system of claim 1, wherein the setting unit is configured to place the cargoes on a lower layer of the loading space as a weight of the cargoes included in the information of the cargoes increases.

4. The cargo loading system of claim 1, wherein the setting unit is configured to set the loading position of the loading space according to an order of delivery from a hub where the cargoes included in the information of the cargoes are loaded to a delivery location.

5. The cargo loading system of claim 4, wherein the setting unit is configured to place the cargoes closer to an entrance of the loading space as a delivery priority of the cargoes is higher.

6. The cargo loading system of claim 1, further including an input unit configured to recognize a loaded cargo and to input the loading position of the cargo set by the setting unit to the control unit when the cargo is recognized.

7. The cargo loading system of claim 6,
wherein the loading position of the cargo is input through the input unit of the cargo when an operator loads the cargo, and the control unit is configured to control the carrier device to carry the cargo to the loading position when the loading position of the cargo is input by the input unit.

8. The cargo loading system of claim 1, further including a detection unit provided at a position where a cargo is loaded in the loading space to detect the cargo and to be connected to the setting unit to confirm the loading position of the cargo.

9. The cargo loading system of claim 8, wherein, when the cargo detected by the detection unit is different from the loading position set by the setting unit, the control unit is configured to generate a warning signal through a portable terminal of the operator.

10. The cargo loading system of claim 1, wherein the loading space includes a left space and a right space at a left side and a right side of the vehicle, and the carrier device is located between the left space and the right space to carry a cargo in the forward and rearward directions of the vehicle.

11. A method for loading a cargo by a cargo vehicle, the method comprising:
setting a loading position of the cargo in a loading space of the cargo vehicle based on a delivery order or a weight of the cargo; and
controlling, by a control unit, a carrier device provided in the loading space of the cargo vehicle to move the cargo in the loading space so that the cargo is carried to the loading position based on a delivery position set in the setting.

12. The method of claim 11, further including:
loading the cargo on the carrier device before the controlling; and
recognizing information of the cargo loaded on the carrier device and inputting a loading position of the recognized cargo,
wherein the controlling includes controlling the carrier device so that the cargo is carried to the loading position of the cargo when the loading position is input in the inputting.

13. The method of claim 12, further including:
determining whether the loading position of the cargo is in the loading space or on the carrier device after the inputting; and
loading the cargo in a temporary space of the loading space when the loading position of the cargo is on the carrier device in the determining.

14. The method of claim 13, further including:
determining whether all cargoes are input in the inputting after the inputting; and
loading the cargo loaded in the temporary space on the carrier device when it is determined that all cargoes are input in the inputting in the determining.

15. The method of claim 14, wherein, when it is determined that all cargoes are not input in the inputting in the determining, the loading of the cargo on the carrier device, the inputting, and the controlling are repeatedly performed.

16. The method of claim 11, further including:
dividing the loading space into a plurality of layers and setting the layers of the loading space according to the weight of the cargo in the setting; and
loading the cargo on a corresponding layer after controlling the carrier device so that the cargo is carried to the loading position in the controlling.

17. The method of claim 16, further including confirming that the cargo is loaded at the set loading position through a detection unit provided in the loading space when the cargo is loaded in the loading space after the loading.

18. The method of claim 11, further including: placing cargoes closer to an entrance of the loading space as a delivery priority of the cargoes is higher.
